(19) United States
(12) Patent Application Publication
(10) Pub. No.: US 2005/0273673 A1
(43) Pub. Date: Dec. 8, 2005

(54) Systems and methods for minimizing security logs

(76) Inventor: Paul Gassoway, Norwood, MA (US)

Correspondence Address: COOPER & DUNHAM, LLP, 1185 AVENUE OF THE AMERICAS, NEW YORK, NY, 10036, US

(21) Appl. No.: 11/132,645

(22) Filed: May 19, 2005

Related U.S. Application Data
(60) Provisional application No. 60/572,351, filed on May 19, 2004.

(51) Int. Cl. G06F 11/00

(52) U.S. Cl. 714/45

(57) ABSTRACT

A method and system for consolidating a computer security log includes providing a security log including information pertaining to security events on a computer system, the log including entries specifying at least information identifying a relative time each event occurred and information identifying a type of each event, determining from the log a number of times a particular type of event occurred during a specified time period and creating a consolidated log including for each entry at least information identifying a first time that the particular type of event occurred during the specified time period, information identifying the type of the particular event and information indicating a number of times the particular type of event occurred during the specified time period.

### REFERENCE TO RELATED APPLICATION

This application is based on and claims the benefit of Provisional Application Ser. No. 60/572,351 filed May 19, 2004, the entire contents of which are herein incorporated by reference.

### BACKGROUND

1. Technical Field

The present disclosure relates to security logs and, more specifically, to systems and methods for minimizing security logs.

2. Description of the Related Art

A computer system, which may include one or more workstations and/or various other types of equipment networked together, may include various types of software and/or hardware systems for protecting the integrity of the computer system. One type of system for protecting the integrity of a computer system is an intrusion detection system. An intrusion refers to a person attempting to gain unauthorized access to a computer system. The intruder may be an outsider or an insider. For example, an outsider may attempt to gain access to a network by bypassing a firewall and gaining access to individual systems on the network. An insider may have authorized access to the network but is attempting to impersonate a higher privileged user to gain access to information the intruder is not authorized to access. There may be various reasons for a person intruding on a system. These reasons may include attempting to access the system simply for the challenge, attempting to access the system to cause some type of damage to the system or website, and those attempting to gain access to the system for profit.

There are various types of intrusion attacks that can take place. These may include, for example, ping sweeps, port scans, etc. to find holes in the system. The intrusion may be an intruder taking advantage of hidden features or bugs in the system for gaining access to the system. Another popular intrusion is where the intruder attempts to crash a system by overloading network links, overloading the CPU or filling up a disk. These intrusion attempts may be referred to as denial-of-service (DoS) attacks.

An intrusion detection system (IDS) attempts to detect intrusions to a computer system. Intrusion detection systems may be host based systems or network based systems. Host based intrusion detection systems reside on a host computer, for example, and attempt to detect intrusions on the host computer. Network based intrusion detection systems may include a stand-alone system connected to a network for monitoring network traffic looking for intrusions.

Examples of types of IDS systems include anomaly detection systems and signature detection systems. Anomaly detection systems attempt to detect statistical anomalies by measuring a “baseline” of stats of the system such as CPU utilization, disk activity, file activity, user logins, etc. When there is a deviation from the baseline, an anomaly or event can be triggered. Signature recognition systems may examine traffic to look for known patterns of attack. A network IDS signature is a pattern of attack that the IDS can look for in the network traffic as an indication of a possible attack. For example, a network intrusion detection system (NIDS) may check for the source address field in an IP header to determine if there is a connection attempt from a reserved IP address. To detect a denial of service attack, a NIDS signature might keep track of how many times a command is issued and provide an alert when the number exceeds a certain threshold. To detect a DNS buffer overflow attempt, a NIDS signature might parse the DNS fields and check the length of each of them. Various other NIDS signatures can be used to detect these and other types of intrusion attempts. Other types of intrusion detection systems include protocol stack verification, application protocol verification, etc.

After an intrusion is detected, various actions can be performed. For example, the system might produce an audio and/or visual signal indicating that the system is under attack, terminate the TCP session, launch another program to handle the attack and/or send an event message to an event log. The event message may include information relating to the attack such as timestamp, intruder IP address, victim IP address/port, protocol information, description of the attach, etc.

Due to the desirability of maintaining an open system having access to the Internet and/or other systems on a network, IDS's inevitably log valid access attempts to the system as well as intrusive access attempts. That is, an IDS may log a large number of events including actual attacks and false positive events. A false positive event is when an IDS reports an attack or attempted attack when no vulnerability exists or no compromise occurs. Very active networks having a high volume of traffic may have event logs containing hundreds of events per second and a large system may generate several gigabytes of event logs daily. When the logs are examined by, for example, a system operator or user, an important event that is in the middle of a large number of false positive events may be missed. The number of events may be intentionally raised by an intruder attempting an attack on the system in order to mask the actual attack. For example, one technique for attacking a machine is to first launch a large number of ineffective attacks in order to overwhelm any IDS software that may be listening, and then launch an effective attack. Even if the IDS detects the effective attack, it will be buried within a large amount of information and may go undetected by the system administrator.

### SUMMARY

A method for consolidating a computer security log comprises providing a security log including information pertaining to security events on a computer system, the log including entries specifying at least information identifying a relative time each event occurred and information identifying a type of each event, determining from the log a number of times a particular type of event occurred during a specified time period and creating a consolidated log including for each entry at least information identifying a first time that the particular type of event occurred during the specified time period, information identifying the type of the particular event and information indicating a number of times the particular type of event occurred during the specified time period.

A programmed computer for consolidating at least one computer security log comprises a system for providing a security log including information pertaining to security events on a computer system, the log including entries specifying at least information identifying a relative time each event occurred and information identifying a type of each event, a system for determining from the log a number of times a particular type of event occurred during a specified time period and a system for creating a consolidated log including for each entry at least information identifying a first time that the particular type of event occurred during the specified time period, information identifying the type of the particular event and information indicating a number of times the particular type of event occurred during the specified time period.

A computer recording medium including computer executable code for consolidating a computer security log comprises code for providing a security log including information pertaining to security events on a computer system, the log including entries specifying at least information identifying a relative time each event occurred and information identifying a type of each event, code for determining from the log a number of times a particular type of event occurred during a specified time period and code for creating a consolidated log including for each entry at least information identifying a first time that the particular type of event occurred during the specified time period, information identifying the type of the particular event and information indicating a number of times the particular type of event occurred during the specified time period.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows an example of a computer system capable of implementing the method and system of the present disclosure;

FIG. 2 shows a plurality of networks on which various aspects of the present disclosure may be implemented.;

FIG. 3 shows an original log prior to consolidation;

FIG. 4 shows a consolidated log, according to an embodiment of the present disclosure;

FIG. 5 shows a plurality of original logs from host systems prior to consolidation; and

FIG. 6 shows a consolidated log according to an embodiment of the present disclosure.

### DETAILED DESCRIPTION

In describing preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

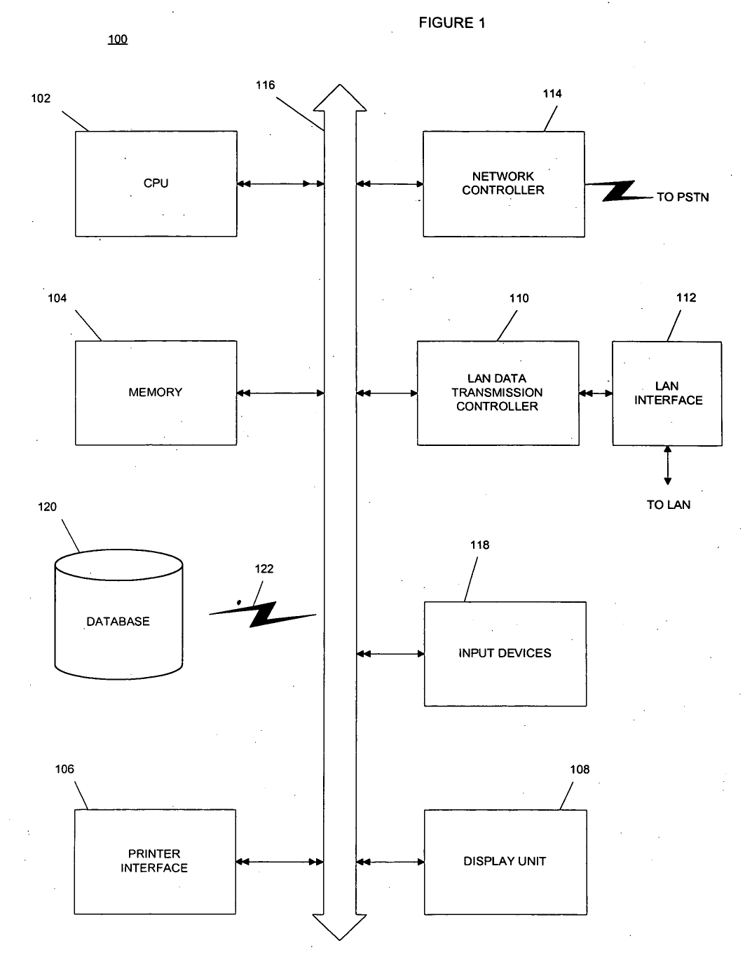

FIG. 1 shows an example of a computer system capable of implementing the method and system of the present disclosure. The system and method of the present disclosure may be implemented in the form of a software application running on a computer system, for example, a mainframe, personal computer (PC), handheld computer, server etc. The software application may be stored on a recording media locally accessible by the computer system, for example, floppy disk, compact disk, hard disk, etc., or may be remote from the computer system and accessible via a hard wired or wireless connection to a network, for example, a local area network, or the Internet.

The computer system referred to generally as system 100 may include a central processing unit (CPU) 102, memory 104, for example, Random Access Memory (RAM), a printer interface 106, a display unit 108, a (LAN) local area network data transmission controller 110, a LAN interface 112, a network controller 114, an internal bus 116 and one or more input devices 118, for example, a keyboard, mouse etc. As shown, the system 100 may be connected to a data storage device, for example, a hard disk, 100, via a link 122.

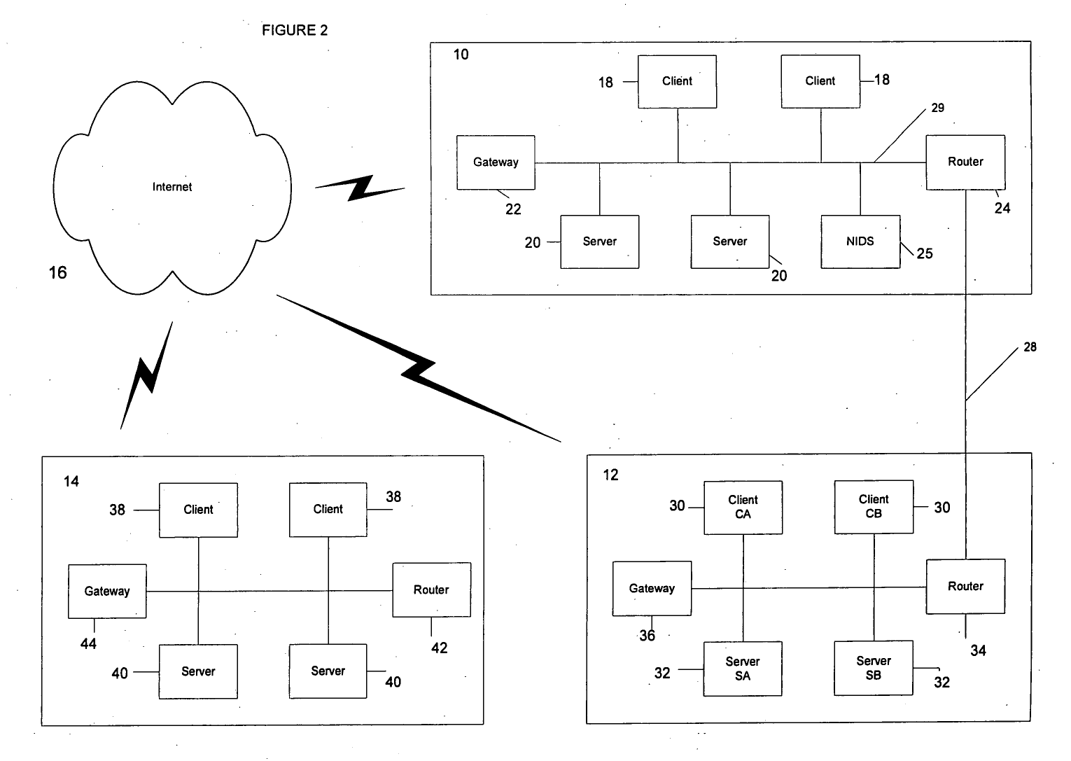

FIG. 2 shows examples of the types of systems in which embodiments of the present disclosure may be implemented. A plurality of networks 10, 12 and 14 are shown. The networks may be connected to the Internet 16. Network 10 includes one or more client computer terminals 18, one or more servers 20 and a gateway 22 which may include a firewall for access to the Internet 16. Computer terminals 18 may be a desktop or laptop computer, a mainframe, etc; Computer terminal(s) 18, server(s) 20 and gateway 22 are interconnected via any preferred type of network connection 29. Router(s) 24 may be used to provide a high speed network link 28 between two or more of the networks. The connections may be wired and/or wireless connections as desired.

Network 12 may include one or more computer terminals 30, one or more servers 32, a router 34 and a gateway 36. Similarly, network 14 may include one or more computer terminals 38, one or more servers 40, a router 42 and a gateway 44. Of course, these are just examples of systems that may be on the network.

According to an embodiment of the present disclosure, a network intrusion detection system (NIDS) 25 may be provided on network 10. NIDS 25 may be any type of system capable of monitoring traffic on network 10 and creating an appropriate IDS log of activity relating thereto. An IDS log is just an example of a type of log to which the present disclosure is directed.

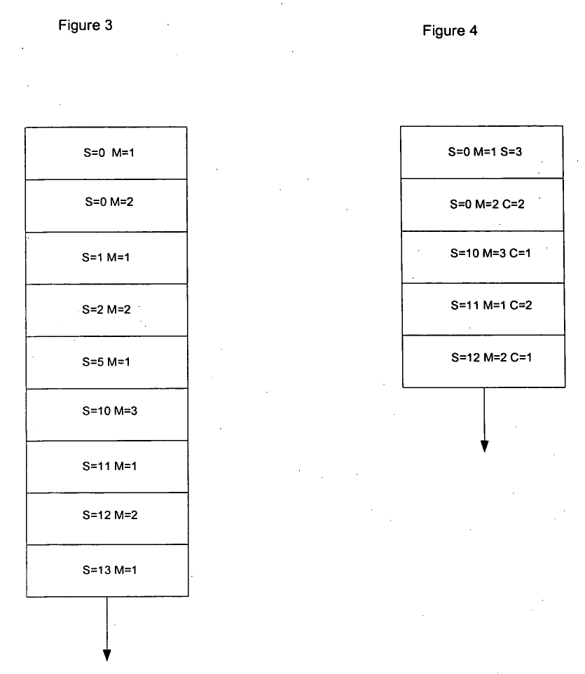

An example of a small portion of an IDS log is shown in FIG. 3 and is referred to generally as original log 60. Each event entry in original log 60 may include a time stamp (S). According to an embodiment, time stamp (S) is the number of seconds since the intrusion detection process started that the event occurred. Each event entry also includes a message descriptor (M) which may be an identifier such as a letter or number identifying the type of intrusion detected. For example, message descriptor M=1 might indicate that a DNS buffer overflow was detected, message descriptor M=2 might indicate a connection attempt from a reserved IP address, etc. Of course, the actual event description may be used in addition to or as an alternative to the descriptors. Event entries may also include additional information if desired. For purposes of ease of discussion, each event entry is represented herein showing only the message descriptor (M) and the time (S) in seconds.

As shown in FIG. 3, in this example the first event occurred within the first second (S=0) of when intrusion detection started and the message descriptor is M=1. An event having a message descriptor M=2 also occurred within the first second of intrusion detection (S=0). Between one and two seconds of the start of intrusion detection (S=1), message descriptor M=1 was again logged. At two seconds, message descriptor M=2 was logged. At five seconds, message descriptor M=1 was again logged. At 10 seconds, message descriptor M=3 was logged. At 11 seconds, message descriptor M=1 was logged. At 12 seconds, message descriptor M=2 was again logged. At 13 seconds, message descriptor M=1 was again logged, etc.

According to this embodiment of the present disclosure, the resolution of the time when messages are logged is set to 1 second. That is, events occurring within the first second are logged as occurring at zero seconds, events occurring between 1 and 2 seconds are logged as occurring at 1 second, etc. Of course, this time can be set to any value as desired. A graphical user interface (GUI) may be provided allowing the system administrator or user to set this resolution.

According to an embodiment of the present disclosure, when a user requests to review an event log according to an embodiment of the present disclosure, the event entries from original log 60 (FIG. 3) are read and consolidated into a consolidated log 62 as shown in FIG. 4 and displayed to the user. Each event entry in consolidated log 62 includes an event descriptor (M), and the number of occurrences (C) of the same message within a defined period of time. For purposes of this description, this defined period of time is 10 seconds. That is, for each 10 second interval, every message having the same message descriptor (M) is consolidated into a single log entry.

For example, the first, third and fifth log entries from original log 60 (FIG. 3) are consolidated into the first entry in consolidated log 62 (FIG. 4). The count (C) represents the number of times that message descriptor “1” occurred during the first 10 second interval. In this example, there were three (C=3) occurrences of message descriptor one (M=1). The value (S=0) indicates that the first occurrence of the event M=1 was within the first second of the intrusion detection starting. The second entry in consolidated log 62 indicates there were two (C=2) occurrences of message descriptor two (M=2), the first occurring within the first second (S=0). Log message descriptor “3” occurred only once during the second ten second time interval at time (S=10). Accordingly, log message descriptor “3” is not consolidated with any others and is displayed by itself in the consolidated log as (S=10 M=3 C=1). Also during the second ten second time interval, message descriptor one (M=1) occurred twice (C=2), with the first occurrence at time S=11. In addition, during the second ten second time interval, message descriptor two (M=2) occurred once (C=1) at time S=12.

There are various ways that the logs can be consolidated. For example, in the above-described embodiment, the consolidation process occurs when the log is being read from memory to be viewed by a user such as a system administrator, for example. The user is thus presented with the consolidated log (FIG. 4). In this way, the system administrator can gain a better view of what occurred on the system without having to look at each individual entry. Of course, the system administrator can be given the option of viewing the original log (FIG. 3) in addition to the consolidated log (FIG. 4).

In an alternative embodiment, instead of storing the original log at all, the log entries can be consolidated as they are being written. In this way, only the consolidated log would be available for viewing by the user. In the alternative, the log entries can be stored in the original log and simultaneously consolidated into a consolidated log as they are being written.

Of course, other variations of the consolidation can be used. For example, according to the above described embodiment, the time displayed in the original log (FIG. 3) is the number of seconds since the intrusion detection process started. However, according to other embodiments, the time could be the time relative to the start of the day, or a representation of the absolute time. In addition, according to the above described embodiment, the time displayed in the consolidated log (FIG. 4) is the number of seconds since the detection process started that the first message of that type appeared in the log during that time interval. However, according to other embodiments, it could be the first second of the time slot. For example, the times S=10, S=11 and S=12 as described in the above-embodiment, would all be displayed as S=10 in the consolidated log entries.

Consolidating the event logs as described herein allows the logs to be more easily reviewed, so that any intrusions are less likely to be missed. Although the log information is being consolidated, very little (if any) important information is being lost.

The system administrator or other user may be given options for controlling the system. For example, according to an embodiment of the present disclosure, the consolidated log 62 can be displayed on a display screen. Using an input device such as a mouse, a cursor can be moved on the screen to one of the log entries. Double clicking on the log entry will display the complete 10 second interval of the original log 60 containing that entry (or entries), in a separate window on the screen. This allows the operator to get an even more detailed view of what occurred during that time interval. According to another embodiment, double clicking on a log entry on the consolidated log 62 will display the 10 second interval of the original log 60 corresponding to that entry as well as the ten second interval prior thereto and/or the 10 second interval following that time interval.

The user may be given the option to set the time intervals being used. For example, a graphical user interface (GUI) can be provided to prompt the user to set the time resolution when the messages are logged in the original log 60. In addition, the user can be prompted to set the 10 second time interval used during consolidation to a more suitable time interval as desired.

The above-embodiments are described with respect to the use of a network based IDS. Of course, a similar log consolidation system could be implemented on a host based IDS in a similar manner.

According to another embodiment of the present disclosure, one or more nodes on network 12 may include host based intrusion detection systems. For example, referring to FIG. 2, client computer system 30 (Client CA) and servers 32 (Servers SA and SB) include host based intrusion detection systems. Client computer system CB includes a system for consolidating all of the event logs from the multiple host based intrusion detection systems into one location, allowing a user to have easy access to all of this information.

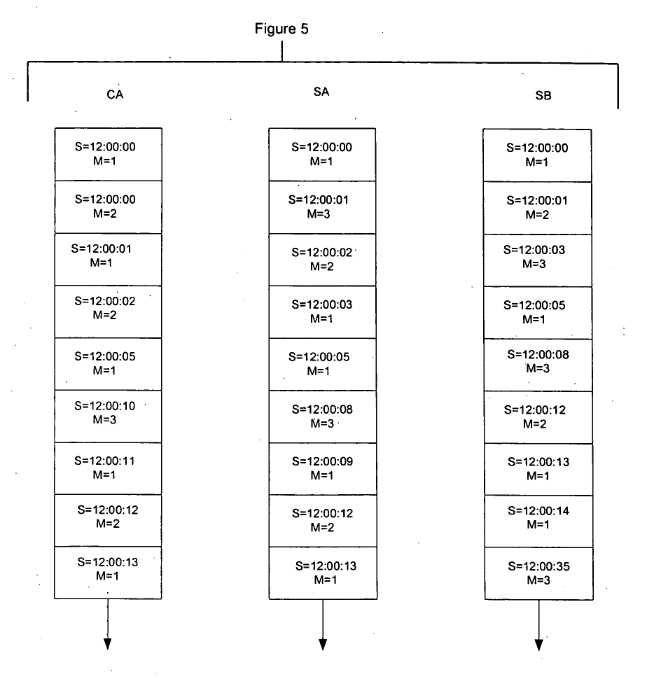

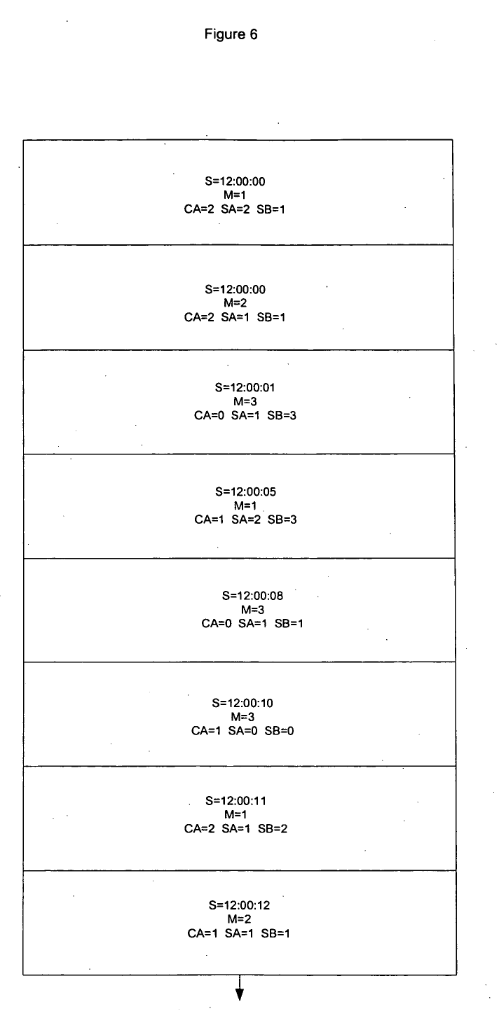

Each host based IDS monitors its corresponding system (CA, SA, SB) and generates a log of intrusion attempts. Periodically, the logs are forwarded to and stored on Client CB. Examples of log files that are transferred from systems CA, SA and SB to client CB are shown in FIG. 5. According to an embodiment of the present disclosure, these event logs can be consolidated by client CB into a consolidated log as shown in FIG. 6.

In this embodiment, the time (S) is represented in military time, according to a system clock. Although the time is represented in military time in this example it could, of course, be represented in standard time. For better accuracy, the system clocks for each of the computers, servers, etc. on network 12 can be periodically synchronized if desired. In the alternative, each node can use a single clock on the network such a system clock provided by one of servers 32. In the consolidated log (FIG. 6), the time (S) is the time at which the earliest occurrence of event (M) occurred in a five second interval. The first occurrence of event M=1 on any of the nodes occurred at time S=12:00:00. As shown, event M=1 occurred twice on client computer system CA (CA=2), twice on server SA (SA=2) and once on server SB (SB=1). Event M=2 first occurred also at time S=12:00:00, and occurred twice on computer system CA (CA=2), once on server SA (SA=1) and once on server SB (SB=1) during the first five second interval. Event M=3 first occurred at time S=12:00:01, and occurred once on server SA (SA=1), three times on server SB (SB=1) and did not occur on client computer system CA (CA=0) during the first five second time interval. During the second five second time interval, event M=1 first occurred at time S=12:00:05 and occurred once on client CA(CA=1), twice on server SA (SA=2) and three times on server SB (SB=1), etc. In this way, the original logs for a plurality of nodes on the network can be consolidated into one consolidated log, allowing an operator to more easily scan the logs to look for abnormal behavior.

The present disclosure may be conveniently implemented using one or more conventional general purpose digital computers and/or servers programmed according to the teachings of the present disclosure. Appropriate software coding can readily be prepared based on the teachings of the present disclosure. The present disclosure may also be implemented by the preparation of application specific integrated circuits or by interconnecting an appropriate network of conventional component circuits.

Numerous additional modifications and variations of the present disclosure are possible in view of the above-teachings. It is therefore to be understood that within the scope of the appended claims, the present disclosure may be practiced other than as specifically described herein.

1. A method for consolidating a computer security log, comprising:
providing a security log including information pertaining to security events on a computer system, the log including entries specifying at least information identifying a relative time each event occurred and information identifying a type of each event;
determining from the log a number of times a particular type of event occurred during a specified time period; and
creating a consolidated log including for each entry at least information identifying a first time that the particular type of event occurred during the specified time period, information identifying the type of the particular event and information indicating a number of times the particular type of event occurred during the specified time period.

2. A method as recited in claim 1, wherein the security events comprise intrusion attempts to the computer system.

3. A method as recited in claim 1, further comprising detecting intrusion detection signatures on the computer system and generating the security log based thereon.

4. A method as recited in claim 3, wherein the intrusion detection signatures comprise patterns in electronic traffic on the computer system.

5. A method as recited in claim 4, wherein the computer system comprises a computer network and the intrusion detection signatures comprise patterns in network traffic.

6. A method as recited in claim 4, wherein the computer system comprises a host computer and the intrusion detection signatures comprise unauthorized access attempts thereto.

7. A method as recited in claim 4, wherein the computer system comprises a plurality of networked host computer systems, the intrusion detection signatures comprise unauthorized access attempts to the host computer systems and wherein the security logs of a plurality of the networked host computer systems are consolidated on one of the networked host computer systems.

8. A programmed computer for consolidating at least one computer security log, comprising:
a system for providing a security log including information pertaining to security events on a computer system, the log including entries specifying at least information identifying a relative time each event occurred and information identifying a type of each event;
a system for determining from the log a number of times a particular type of event occurred during a specified time period; and
a system for creating a consolidated log including for each entry at least information identifying a first time that the particular type of event occurred during the specified time period, information identifying the type of the particular event and information indicating a number of times the particular type of event occurred during the specified time period.

9. A programmed computer as recited in claim 8, wherein the security events comprise intrusion attempts to the computer system.

10. A programmed computer as recited in claim 8, further comprising detecting intrusion detection signatures on the computer system and generating the security log based thereon.

11. A programmed computer as recited in claim 10, wherein the intrusion detection signatures comprise patterns in electronic traffic on the computer system.

12. A programmed computer as recited in claim 11, wherein the computer system comprises a computer network and the intrusion detection signatures comprise patterns in network traffic.

13. A programmed computer as recited in claim 11, wherein the computer system comprises a host computer and the intrusion detection signatures comprise unauthorized access attempts thereto.

14. A programmed computer as recited in claim 11, wherein the computer system comprises a plurality of networked host computer systems, the intrusion detection signatures comprise unauthorized access attempts to the host computer systems and wherein the security logs of a plurality of the networked host computer systems are consolidated on said programmed computer.

15. A computer recording medium including computer executable code for consolidating a computer security log, comprising:
code for providing a security log including information pertaining to security events on a computer system, the log including entries specifying at least information identifying a relative time each event occurred and information identifying a type of each event;
code for determining from the log a number of times a particular type of event occurred during a specified time period; and
code for creating a consolidated log including for each entry at least information identifying a first time that the particular type of event occurred during the specified time period, information identifying the type of the particular event and information indicating a number of times the particular type of event occurred during the specified time period.

16. A computer recording medium as recited in claim 15, wherein the security events comprise intrusion attempts to the computer system.

17. A computer recording medium as recited in claim 15, further comprising code for detecting intrusion detection signatures on the computer system and generating the security log based thereon.

18. A computer recording medium as recited in claim 17, wherein the intrusion detection signatures comprise patterns in electronic traffic on the computer system.

19. A computer recording medium as recited in claim 18, wherein the computer system comprises a computer network and the intrusion detection signatures comprise patterns in network traffic.

20. A computer recording medium as recited in claim 18, wherein the computer system comprises a host computer and the intrusion detection signatures comprise unauthorized access attempts thereto.

21. A computer recording medium as recited in claim 18, wherein the computer system comprises a plurality of networked host computer systems, the intrusion detection signatures comprise unauthorized access attempts to the host computer systems and wherein the security logs of a plurality of the networked host computer systems are consolidated on one of the networked host computer systems.
